(19) United States
(12) Patent Application Publication
(10) Pub. No.: US 2026/0301462 A1
(43) Pub. Date: Oct. 1, 2026

(54) STREAMING SYSTEM, STREAMING METHOD, AND STORAGE MEDIUM

(71) Applicant: HONDA MOTOR CO., LTD., Tokyo (JP)

(72) Inventor: Kenta Maruyama, Tokyo (JP)

(21) Appl. No.: 19/556,546

(22) Filed: Mar. 4, 2026

(30) Foreign Application Priority Data
Mar. 28, 2025 (JP) 2025-056402

(51) Int. Cl. G06V 40/16; B60K 35/22

(52) U.S. Cl. CPC G06V 40/172; B60K 35/22

(57) ABSTRACT

A streaming system including: a streaming unit that streams an image obtained through capturing by a first capturing apparatus provided in a vehicle; a terminal apparatus that is provided in a location other than the vehicle and displays the streamed image; a viewing-side face identification unit that identifies a face based on a capturing result from a second capturing apparatus provided in the terminal apparatus, while the terminal apparatus is displaying the streamed image; and a first notification unit that notifies an occupant of the vehicle by displaying a predetermined mark on a display apparatus provided in the vehicle, when the viewing-side face identification unit identifies a face other than that of a specific viewer.

### INCORPORATION BY REFERENCE

The present application claims priority under 35 U.S.C. § 119 to Japanese Patent Application No. 2025-056402 filed on Mar. 28, 2025. The content of the application is incorporated herein by reference in its entirety.

### BACKGROUND OF THE INVENTION

### Field of the Invention

The present invention relates to a streaming system, a streaming method, and a storage medium.

### Description of the Related Art

In recent years, efforts have been accelerating to provide access to sustainable transportation systems that take into account vulnerable traffic participants such as the elderly, people with disabilities, and children. To this end, efforts are focused on research and development for further improving the safety and convenience of traffic through the development of means of transportation for vulnerable road users. There is a method of viewing, as a viewer, a moving image streamed by a streamer of an image (for example, see Japanese Patent Laid-Open No. 2024-039763), without a person in a vulnerable position personally having to enter a mobile body to access a transportation system. Japanese Patent Laid-Open No. 2024-039763 discloses transmitting an image captured by a camera unit provided in a vehicle to an apparatus used at a different location than the vehicle.

However, behavior of the occupant of the vehicle may change during streaming of the image depending on whether a specific viewer is viewing the streamed image or a third party other than the specific viewer is viewing the streamed image. Japanese Patent Laid-Open No. 2024-039763 does not consider whether, along with the specific viewer, a third party other than the specific viewer is viewing the streamed image displayed on a terminal apparatus provided in a location other than the vehicle. Therefore, there is a problem with the conventional technology as disclosed in Japanese Patent Laid-Open No. 2024-039763 in that the occupant is not capable of knowing whether the image displayed on the terminal apparatus is being viewed by a third party other than the specific viewer.

In order to solve the above problem, the present application has an object to provide a streaming system, a streaming method, and a storage medium that allow an occupant to know whether an image displayed on a terminal apparatus is being viewed by a third party other than a specific viewer.

Therefore, through a service for connecting remote locations and vehicles, the present invention contributes to supporting good connection between urban areas and regional areas such as those surrounding urban areas, and to the development of sustainable transportation systems.

### SUMMARY OF THE INVENTION

An aspect of the present invention is a streaming system including: a streaming unit configured to stream an image obtained through capturing by a first capturing apparatus provided in a vehicle; a terminal apparatus provided in a location other than the vehicle and configured to display the streamed image; a viewing-side face identification unit configured to identify a face based on a capturing result from a second capturing apparatus provided in the terminal apparatus, while the terminal apparatus is displaying the streamed image; and a first notification unit configured to notify an occupant of the vehicle by displaying a predetermined mark on a display apparatus provided in the vehicle, when the viewing-side face identification unit identifies a face other than that of a specific viewer.

According to the present invention, the occupant is capable of knowing whether an image displayed on a terminal apparatus is being viewed by a third party other than a specific viewer.

### BRIEF DESCRIPTION OF THE DRAWINGS

FIG. 1 is a diagram showing a system configuration of a streaming system;

FIG. 2 is a block diagram showing a configuration of an in-vehicle apparatus and a streaming server;

FIG. 3 is a diagram showing a detailed configuration of a first control section of the in-vehicle apparatus;

FIG. 4 is a diagram showing a configuration of a user information DB;

FIG. 5 is a diagram showing a configuration of a stream management DB;

FIG. 6 is a block diagram showing a configuration of a viewer terminal;

FIG. 7 shows flowcharts showing an operation of the in-vehicle apparatus, the streaming server, and the viewer terminal; and

FIG. 8 shows flowcharts showing an operation of the in-vehicle apparatus, the streaming server, and the viewer terminal.

### DETAILED DESCRIPTION OF THE INVENTION

Hereinafter, an embodiment of the present invention will be described with reference to the drawings.

### 1. Configuration of Streaming System

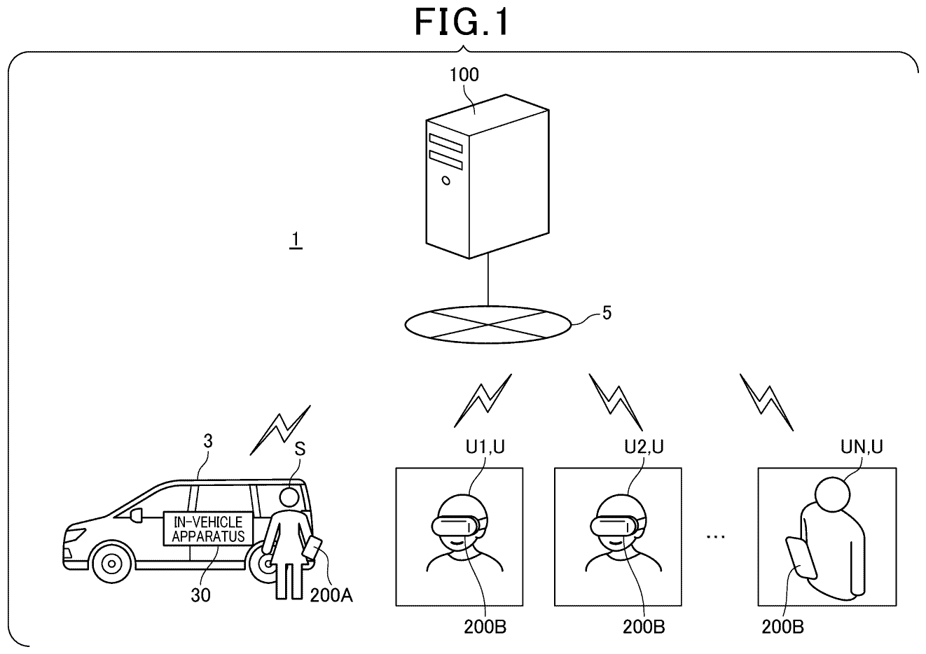

FIG. 1 is a diagram showing a system configuration of a streaming system 1.

The streaming system 1 includes a vehicle 3, an in-vehicle apparatus 30 included in the vehicle 3, a streamer terminal 200A provided in the vehicle 3, a streaming server 100, and a viewer terminal 200B provided in a location other than the vehicle 3. The streaming system 1 is a system for live streaming content including an image obtained through capturing by the streamer terminal 200A. The viewer terminal 200B is an example of a “terminal apparatus.” The streamer terminal 200A is an example of a “first capturing apparatus.”

Live streaming refers to streaming the image obtained through capturing by the streamer terminal 200A to the viewer terminal 200B in real-time. The image may be a still image or a moving image.

The in-vehicle apparatus 30 is installed in the vehicle 3 and is wirelessly connected via short-range wireless communication or the like to the streamer terminal 200A possessed by a streamer S being an occupant of the vehicle 3.

The in-vehicle apparatus 30 receives, from the streamer terminal 200A, content data including an image captured by a camera included in the streamer terminal 200A and speech input via a microphone included in the streamer terminal 200A. The in-vehicle apparatus 30 uploads the received content data to the streaming server 100.

The streamer terminal 200A is a smartphone, a tablet personal computer (PC) or the like as an example of the first capturing apparatus. As long as the streamer S is depicted in the image obtained through capturing by the streamer terminal 200A, the streamer terminal 200A may be placed at any location inside the vehicle 3. For example, the streamer terminal 200A is supported by a predetermined support provided at a passenger seat of the vehicle 3.

Note that the first capturing apparatus provided in the vehicle 3 may be a camera such as a digital camera that can communicate with the in-vehicle apparatus 30 or a 360-degree camera that can capture an entire surrounding area. In this case, the microphone and the camera may be implemented separately.

The streaming server 100 stores the content received from the in-vehicle apparatus 30 in a server storage unit. The streaming server 100 streams the uploaded content data to the viewer terminal 200B of a viewer U. Live streaming technology can be realized using known technology such as HTTP Live Streaming (HLS), Common Media Application Format (CMAF), Web Real-Time Communication (WebRTC), or Real-Time Messaging Protocol (RTMP).

The viewer terminal 200B is a terminal apparatus possessed by the viewer U that views the content data streamed from the streaming server 100. FIG. 1 shows U1, U2, . . . , UN viewers U as the viewer U. N is an arbitrary natural number.

For example, the viewer terminal 200B may be a portable or mobile terminal apparatus such as a smartphone, a tablet PC, or a notebook PC, or may be a stationary terminal apparatus such as a desktop PC. The viewer terminal 200B may be a television set, or a head-mounted display apparatus in which an image display part is mounted on the head of the viewer U and a display included in the image display part is arranged in front of the eyes of the viewer U. The head-mounted display apparatus may be transmissive or non-transmissive, as long as the content streamed from the streaming server 100 can be viewed.

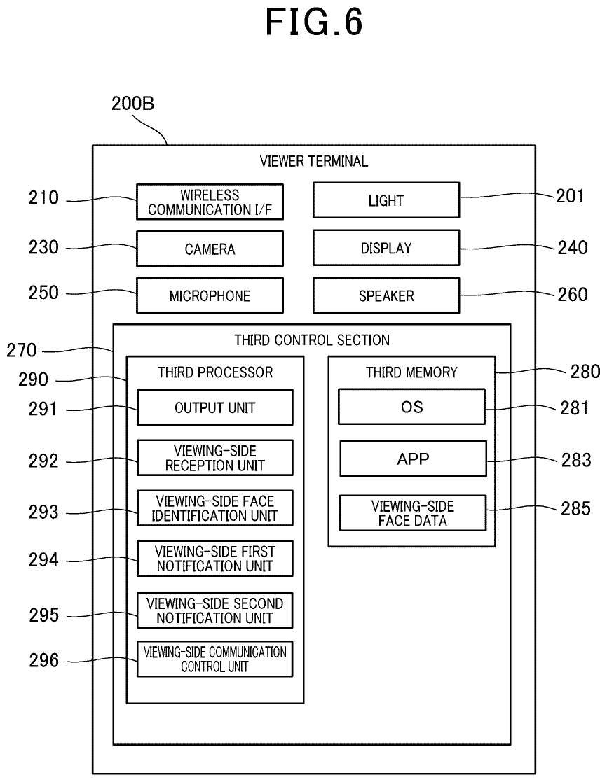

The viewer terminal 200B includes a display 240 (see FIG. 6) and a speaker 260 (see FIG. 6), displays an image streamed from the in-vehicle apparatus 30 or the streaming server 100 on the display 240, and outputs speech streamed from the in-vehicle apparatus 30 or the streaming server 100 via the speaker 260.

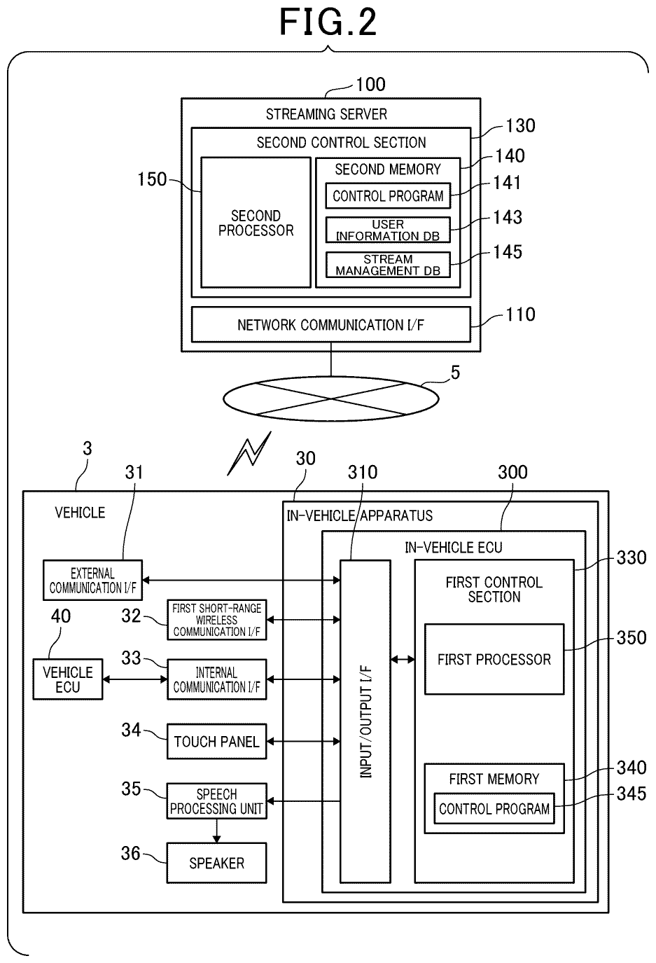

The viewer terminal 200B includes a microphone 250 (see FIG. 6) and uploads speech data of the viewer U collected by the microphone 450 to the streaming server 100. The streaming server 100 transmits the uploaded speech data of the viewer U to the in-vehicle apparatus 30. The in-vehicle apparatus 30 then outputs the speech indicated by the received speech data of the viewer U in the vehicle 3 via a speaker 36 (see FIG. 2). With this, the viewer U and the streamer S can converse during streaming of the content.

A communication network 5 is a wired or wireless transmission path for information transmitted from an apparatus connected to the communication network 5. For example, the communication network 5 may include a public network such as the Internet, a mobile communication network, a satellite communication network, or various local area networks (LANs) including Ethernet (registered trademark) or a wide area network (WAN). The communication network 5 may include a dedicated network such as an Internet protocol-virtual private network (IP-VPN).

### 2. Configuration of In-Vehicle Apparatus

FIG. 2 is a diagram showing a configuration of the vehicle 3 and the streaming server 100.

First, the configuration of the vehicle 3 will be described with reference to FIG. 2.

The vehicle 3 includes the in-vehicle apparatus 30, an external communication interface 31, a first short-range wireless communication interface 32, an internal communication interface 33, a touch panel 34, a speech processing unit 35, the speaker 36, a vehicle electronic control unit (ECU) 40, and an in-vehicle ECU 300. Hereinafter, interface will be abbreviated as I/F as appropriate. The touch panel 34 is an example of a “display apparatus.”

The external communication I/F 31 is a communication module that performs wireless communication in accordance with a mobile communication standard such as long-term evolution (LTE), fourth-generation (4G), 5G, or Wi-Fi (registered trademark). The external communication I/F 31 is connected to the communication network 5 via an antenna (not shown) and performs mutual data transmission/reception with the streaming server 100.

For example, the first short-range wireless communication I/F 32 is a communication apparatus that performs wireless communication in accordance with a short-range wireless communication standard such as Bluetooth (registered trademark) or Wi-Fi. For example, the first short-range wireless communication I/F 32 is a communication module that performs communication in accordance with a near-field communication (NFC) standard such as Bluetooth or Wi-Fi. The first short-range wireless communication I/F 32 performs short-range wireless communication with the streamer terminal 200A possessed by the streamer S being the occupant, and receives an image, speech, and the like captured by the streamer terminal 200A.

The internal communication I/F 33 is an input/output interface connected to an in-vehicle network (not shown). For example, a communication bus supporting a communication standard such as controller area network (CAN), CAN with Flexible Data-Rate (CAN FD), or Ethernet is used for the in-vehicle network. The internal communication I/F 33 performs mutual data communication via the in-vehicle network with in-vehicle equipment such as a vehicle ECU 40 or another relay apparatus.

The touch panel 34 includes a display panel such as a liquid-crystal panel or an organic electroluminescent (EL) panel, and a touch sensor. The touch sensor detects a touch operation by the viewer U on the touch panel 34 and outputs position information indicating a position of the detected touch operation to a first control section 330.

For example, the speech processing unit 35 includes a processor and converts digital speech data output by the first control section 330 into an analog speech signal. The speech processing unit 35 amplifies the converted analog speech signal and outputs the amplified speech signal via the speaker 36.

The in-vehicle ECU 300 includes an input/output I/F 310 and the first control section 330.

The input/output I/F 310 functions as a connection unit between the first control section 330 and the external communication I/F 31, the first short-range wireless communication I/F 32, the internal communication I/F 33, the touch panel 34, and the speech processing unit 35. The input/output I/F 310 includes a connector and an interface circuit. The input/output I/F 310 outputs data input from the external communication I/F 31, the first short-range wireless communication I/F 32, the internal communication I/F 33, the touch panel 34, and the speech processing unit 35 to the first control section 330. The input/output I/F 310 outputs data input from the first control section 330 to the external communication I/F 31, the first short-range wireless communication I/F 32, the internal communication I/F 33, the touch panel 34, or the speech processing unit 35.

The first control section 330 is a computer apparatus including a first memory 340 and a first processor 350.

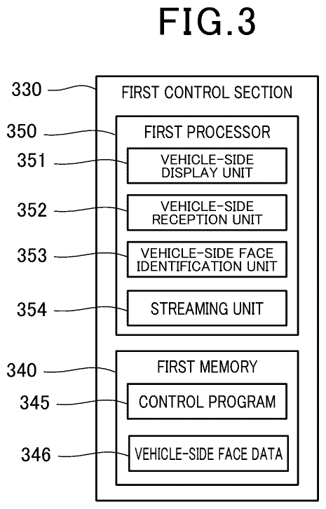

FIG. 3 is a diagram showing a detailed configuration of the first control section 330 of the in-vehicle apparatus 30.

The first memory 340 includes, for example, a volatile semiconductor memory and a non-volatile semiconductor memory. The first memory 340 may include only a non-volatile semiconductor memory. The first memory 340 may include an auxiliary storage apparatus such as a solid-state drive (SSD). The first memory 340 stores a control program 345 executed by the first processor 350, configuration data that defines an operation of the in-vehicle apparatus 30, and the like.

The first memory 340 stores the control program 345 and vehicle-side face data 346.

The vehicle-side face data 346 is data indicating information relating to a face corresponding to the streamer S. The information relating to the face is information indicating characteristics of the face used in so-called facial recognition technology. The information relating to the face corresponding to the streamer S per vehicle 3 is stored in advance in the vehicle-side face data 346.

The first processor 350 is, for example, an arithmetic processing apparatus such as a central processing unit (CPU) or a microprocessing unit (MPU). The first processor 350 may be implemented as a single processor or as a plurality of processors. The first processor 350 may be implemented as a system on a chip (SoC) integrated with part or all of the first memory 340, or with another circuit.

The first processor 350 includes, as functional units, a vehicle-side display unit 351, a vehicle-side reception unit 352, a vehicle-side face identification unit 353, and a streaming unit 354. These functional units are realized through cooperation between hardware and software, by the first processor 350 loading and executing the control program 345 stored in the first memory 340.

The vehicle-side display unit 351 displays a screen via the touch panel 34.

The vehicle-side display unit 351 may display, as a preview, an image included in the streamed content.

The vehicle-side display unit 351 displays a predetermined mark when a viewing-side face identification unit 293 of the viewer terminal 200B to be described below detects that a third party other than the viewer U is depicted. The predetermined mark is a mark that informs the streamer S that a third party is depicted on the viewer terminal 200B.

The predetermined mark may, for example, be a mark including a text “A third party is depicted.” The predetermined mark may be an image showing that a third party is depicted. The predetermined mark is displayed superimposed on various screens displayed by the vehicle-side display unit 351. For example, the predetermined mark is displayed superimposed on the screen displaying the image included in the streamed content as the preview.

The vehicle-side reception unit 352 accepts an operation of an input via the touch panel 34 or other input means.

The vehicle-side reception unit 352 accepts, from a predetermined screen, an input indicating an instruction to start streaming the content.

The vehicle-side reception unit 352 accepts, from the predetermined screen, an input indicating an instruction to lift a prohibition on streaming the content and to start streaming the content.

The vehicle-side reception unit 352 accepts, from the predetermined screen, an input indicating an instruction to not start streaming the content.

The vehicle-side face identification unit 353 identifies, based on the image obtained through capturing by the streamer terminal 200A, a face depicted in the image.

In particular, the vehicle-side face identification unit 353 identifies whether the face depicted in the image is the face corresponding to the streamer S indicated in the vehicle-side face data 346. The face corresponding to the streamer S indicated in the vehicle-side face data 346 corresponds to a face corresponding to a specific occupant.

The vehicle-side face identification unit 353 identifies the face of a user seated in a driver seat. That is, the vehicle-side face identification unit 353 especially identifies the face of a driver from among occupants of the vehicle 3. Note that the present invention is not limited thereto. The vehicle-side face identification unit 353 may identify, based on the image obtained through capturing by the streamer terminal 200A, all faces depicted in the image inside the vehicle 3.

When someone other than the streamer S is depicted in the image obtained through capturing by the streamer terminal 200A, the vehicle-side face identification unit 353 prohibits starting the streaming of the content.

The streaming unit 354 communicates with the streaming server 100 and the viewer terminal 200B in accordance with a predetermined communication standard.

The streaming unit 354 uploads the content data to the streaming server 100 via the external communication I/F 31. The content data includes the image obtained through capturing by the streamer terminal 200A, speech obtained through sound collection by the streamer terminal 200A, a stream identification (ID), and the like.

When the vehicle-side face identification unit 353 detects that someone other than the streamer S is depicted in the image obtained through capturing by the streamer terminal 200A, the streaming unit 354 prohibits starting the streaming of the content. The streaming unit 354 is an example of a “prohibition unit.”

### 3. Configuration of Streaming Server

Next, the configuration of the streaming server 100 will be described.

The streaming server 100 includes a network communication I/F 110 and a second control section 130.

For example, the network communication I/F 110 includes a communication card such as a network interface card (NIC), and performs mutual data communication via the communication network 5 with the in-vehicle apparatus 30, the viewer terminal 200B, and the like.

The second control section 130 is a computer apparatus including a second memory 140 and a second processor 150.

The second memory 140 includes, for example, a volatile semiconductor memory and a non-volatile semiconductor memory. The second memory 140 may include only a non-volatile semiconductor memory. The second memory 140 may include an auxiliary storage apparatus such as a hard disk drive (HDD) or an SSD.

The second memory 140 stores a control program 141 executed by the second processor 150, a user information database 143, a stream management database 145, and a content database 147. Hereinafter, database will be abbreviated as DB.

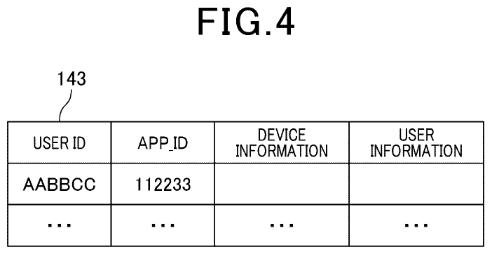

FIG. 4 is a diagram showing a configuration of the user information DB 143.

One record in the user information DB 143 includes a user ID, APP_ID, device information, user information, and terminal identification information. APP is an abbreviation of application program.

The user ID is identification information for identifying a user utilizing a streaming service provided by the streaming server 100. The user includes the streamer S and the viewer U.

APP_ID is identification information for identifying an application program downloaded on the streamer terminal 200A or the viewer terminal 200B.

The streamer S and the viewer U download the APP from a predetermined website and respectively install the APP on the streamer terminal 200A and the viewer terminal 200B.

The device information is identification information for identifying the viewer terminal 200B. The device information is, for example, information indicating whether the viewer terminal 200B is a smartphone, a PC, a head-mounted display apparatus, or a camera. For example, a model number is used for the device information.

The user information is personal information of the streamer S and the viewer U being the user. The user information includes, for example, information such as name, address, sex, and age.

As described above, the terminal identification information is identification information for uniquely identifying the viewer terminal 200B. The viewer terminal 200B associated with information of the viewer U is uniquely identified, by associating the user information and the terminal identification information in the user information DB 143.

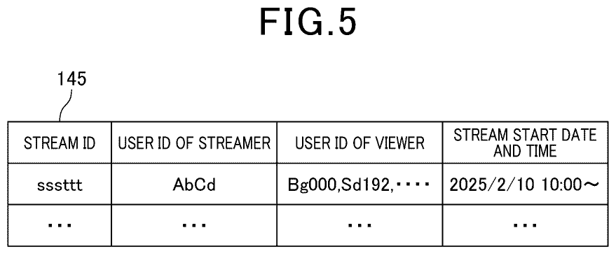

FIG. 5 is a diagram showing a configuration of the stream management DB 145.

One record in the stream management DB 145 includes a stream ID for identifying a stream, the user ID of the streamer S, the user ID of the viewer U, and a stream start date and time.

Returning to FIG. 2, the configuration of the streaming server 100 will be described further.

The second processor 150 is, for example, an arithmetic processing apparatus such as a CPU or an MPU. The second processor 150 may be implemented as a single processor or as a plurality of processors. The second processor 150 may be implemented as an SoC integrated with part or all of the second memory 140, or with another circuit.

### 4. Configuration of Viewer Terminal

FIG. 6 is a block diagram showing a configuration of the viewer terminal 200B.

The viewer terminal 200B includes a wireless communication I/F 210, a light 201, a camera 230, the display 240, the microphone 250, the speaker 260, and a third control section 270. The camera 230 is an example of a “second capturing apparatus.”

The light 201 is a light-emitting diode (LED). Note that the light 201 is not limited to being an LED as long as the light 201 is a light-emitting member.

For example, the second short-range wireless communication I/F 220 is a communication module that performs communication in accordance with an NFC standard such as Bluetooth or Wi-Fi. The second short-range wireless communication I/F 220 transmits a captured image captured by the camera 230, speech input via the microphone 250, and the like to the in-vehicle apparatus 30 through short-range wireless communication with the in-vehicle apparatus 30.

The camera 230 is a capturing apparatus including an image sensor and a data processing circuit. The image sensor is implemented as, for example, a charge-coupled device (CCD) or a complementary metal-oxide-semiconductor (CMOS). The data processing circuit generates a captured image from an output of the image sensor.

The microphone 250 is a speech input apparatus for inputting speech of the viewer U. The speaker 260 is a speech output apparatus for outputting speech of the viewer U.

The display 240 includes a display panel such as a liquid-crystal panel or an organic EL panel. When the viewer terminal 200B is a smartphone, a tablet PC, or the like, the display 240 is a touch panel including a touch sensor.

In this case, the display 240 functions as display means for displaying an image and as reception means for accepting an operation by the streamer S, the viewer U, and the like.

Note that when the viewer terminal 200B is a head-mounted display apparatus, detection means for detecting a direction in which the eyes, the face, and the like of the viewer U are oriented or a gesture of the viewer U functions as the reception means.

The third control section 270 is a computer apparatus including a third memory 280 and a third processor 290.

The third memory 280 includes a non-volatile semiconductor memory. The third memory 280 may include an auxiliary storage apparatus such as an SD card. The third memory 280 stores control programs such as an operating system (OS) 281 and an APP 283, and viewing-side face data 285. The APP 283 is an application program that performs mutual data communication with the streaming server 100, displays a moving image included in content streamed by the streaming server 100 on the display 240, and outputs speech included in the content to the speaker 260. The APP 283 is an example of a “program.”

The viewing-side face data 285 is data indicating information relating to a face corresponding to the viewer U. The information relating to the face is information indicating characteristics of the face used in so-called facial recognition technology. The information relating to the face corresponding to the viewer U per viewer terminal 200B is stored in advance in the viewing-side face data 285.

The third processor 290 is, for example, an arithmetic processing apparatus such as a CPU or an MPU. The third processor 290 may be implemented as a single processor or as a plurality of processors.

The third processor 290 includes, as functional units, an output unit 291, a viewing-side reception unit 292, the viewing-side face identification unit 293, a viewing-side first notification unit 294, a viewing-side second notification unit 295, and a viewing-side communication control unit 296. These functional units are realized through cooperation between hardware and software, by the third processor 290 loading and executing the APP 283 stored in the third memory 280.

The viewing-side first notification unit 294 is an example of a “first notification unit.” The viewing-side second notification unit 295 is an example of a “second notification unit.”

The output unit 291 outputs the image included in the content streamed by the in-vehicle apparatus 30 or the streaming server 100 to the display 240, that is, displays the image on the display 240.

The output unit 291 outputs the speech included in the content streamed by the in-vehicle apparatus 30 or the streaming server 100 from the speaker 260.

The output unit 291 outputs light via the light 201.

The viewing-side reception unit 292 accepts various input from the viewer U.

The viewing-side face identification unit 293 captures via the camera 230 while the APP 283 is running. The viewing-side face identification unit 293 identifies, based on an image obtained through capturing by the camera 230, a face depicted in the image.

In particular, the viewing-side face identification unit 293 identifies whether the face depicted in the image is the face corresponding to the viewer U indicated in the viewing-side face data 285. The face corresponding to the viewer U indicated in the viewing-side face data 285 corresponds to a face corresponding to a specific viewer U.

The viewing-side first notification unit 294 notifies the streamer S corresponding to the occupant of the vehicle 3 that a face corresponding to someone other than the viewer U has been identified, by displaying the predetermined mark on the touch panel 34 provided in the vehicle 3.

The viewing-side second notification unit 295 notifies the viewer U that a face corresponding to someone other than the specific viewer U has been identified.

The viewing-side communication control unit 296 communicates with the streaming server 100 via the wireless communication I/F 210. The viewing-side communication control unit 296 communicates with the in-vehicle apparatus 30 or the streamer terminal 200A via the wireless communication I/F 210.

### 5. Operation

Next, an operation of the streaming system 1 will be described.

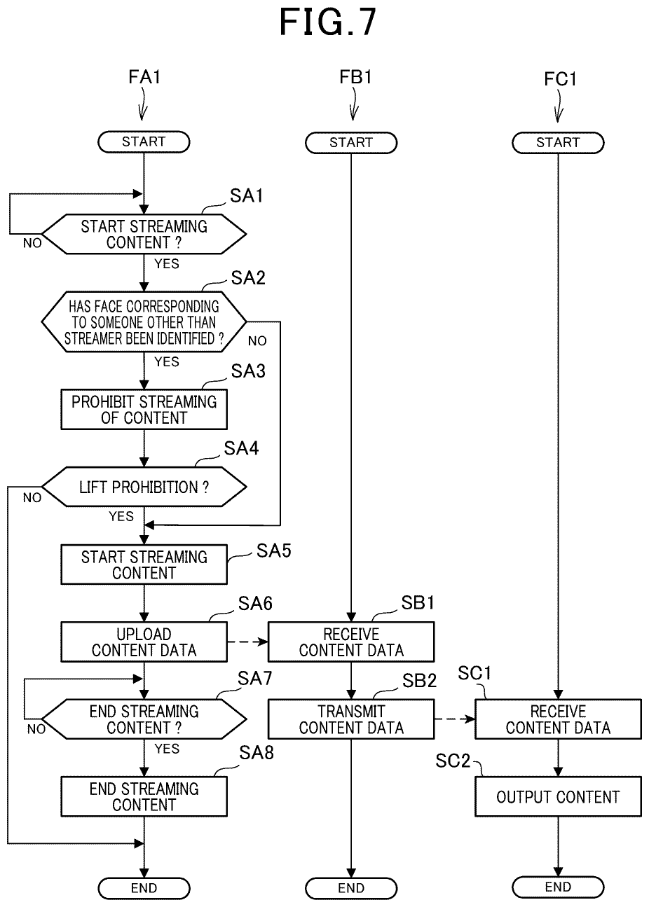

FIG. 7 shows flowcharts showing an operation of the in-vehicle apparatus 30, the streaming server 100, and the viewer terminal 200B.

In the operation of the in-vehicle apparatus 30, the streaming server 100, and the viewer terminal 200B described in FIG. 7, it is assumed that communication is established between the in-vehicle apparatus 30 and the streaming server 100 and between the streaming server 100 and the viewer terminal 200B, and that the viewer terminal 200B can start viewing the streamed image.

First, the operation of each unit of the streaming system 1 during streaming of the content will be described.

In FIG. 7, a flowchart FA1 indicates the operation of the in-vehicle apparatus 30, a flowchart FB1 indicates the operation of the streaming server 100, and a flowchart FC1 indicates the operation of the viewer terminal 200B.

As shown in the flowchart FA1, the streaming unit 354 determines whether to start streaming the content (step SA1).

For example, when the touch panel 34 receives a streaming start instruction, the streaming unit 354 makes a positive determination in step SA1.

For example, when the in-vehicle apparatus 30 receives streaming start information from the streamer terminal 200A, the streaming unit 354 makes the positive determination in step SA1. Note that the streaming start information is information indicating the start of streaming.

When the streaming unit 354 determines to start streaming the content (YES in step SA1), the vehicle-side face identification unit 353 determines whether a face corresponding to someone other than the streamer S has been identified based on the image obtained through capturing by the streamer terminal 200A (step SA2). Step SA2 is an example of a “vehicle-side face identification step.”

When a face corresponding to someone other than the streamer S has been identified (YES in step SA2), the vehicle-side face identification unit 353 prohibits streaming of the content (step SA3). Step SA3 is an example of a “prohibition step.”

Subsequently, the streaming unit 354 determines whether to lift the prohibition on streaming the content (step SA4). For example, when the vehicle-side reception unit 352 accepts an instruction to lift the prohibition on streaming the content, the streaming unit 354 makes a positive determination in step SA4. When the vehicle-side reception unit 352 receives the instruction not to start streaming the content while prohibiting the streaming of the content, the streaming unit 354 makes a negative determination in step SA4. In this case, the vehicle-side display unit 351 outputs, for example, a screen for the occupant to input an instruction indicating whether to start streaming the content.

When the streaming unit 354 determines not to lift the prohibition on streaming the content (NO in step SA4), the operation shown in FIG. 7 is ended.

When the streaming unit 354 determines to lift the prohibition on streaming the content (YES in step SA4) and the vehicle-side face identification unit 353 has not identified a face corresponding to someone other than the streamer S (NO in step SA2), the streaming unit 354 starts streaming the content (step SA5). Upon starting streaming of the content, the streaming unit 356 uploads the content data at predetermined intervals to the streaming server 100 (step SA6).

Step SA6 is an example of a “streaming step.”

As shown in the flowchart FB1, the second control section 130 of the streaming server 100 receives the content data from the in-vehicle apparatus 30 (step SB1).

Subsequently, the second control section 130 of the streaming server 100 transmits the received content data to the viewer terminal 200B (step SB2).

Step SB2 will be described in detail below. The second control section 130 identifies a record including the stream ID received together with the content data from the stream management DB 145 and acquires the user ID of the viewer U from the identified record. Subsequently, the second control section 130 acquires the device information per acquired user ID of the viewer U. The second control section 130 then transmits the received content data, based on the communication information included in the acquired device information.

As shown in the flowchart FC, the viewing-side communication control unit 296 of the viewer terminal 200B receives the content data from the streaming server 100 (step SC1).

Subsequently, the output unit 291 displays the image included in the content indicated by the received content data on the display 240 and outputs the speech included in the content indicated by the received content data via the speaker 260 (step SC2).

Step SC2 is an example of a “viewing-side display step.”

Returning to the description of the flowchart FA1, the streaming unit 354 determines whether to end streaming the content (step SA7).

For example, when the touch panel 34 receives a streaming end instruction, the streaming unit 354 makes a positive determination in step SA7.

For example, when the in-vehicle apparatus 30 receives streaming end information from the streamer terminal 200A, the streaming unit 354 makes the positive determination in step SA7. Note that the streaming end information is information indicating the end of streaming.

When determining not to end streaming the content (NO in step SA7), the streaming unit 354 returns the processing to step SA6 and performs the processing from step SA6 onward once more. Note that the streaming unit 356 continues streaming the content until a positive determination is made in step SA7.

On the other hand, when determining to end streaming the content (YES in step SA7), the streaming unit 356 ends streaming the content (step SA8).

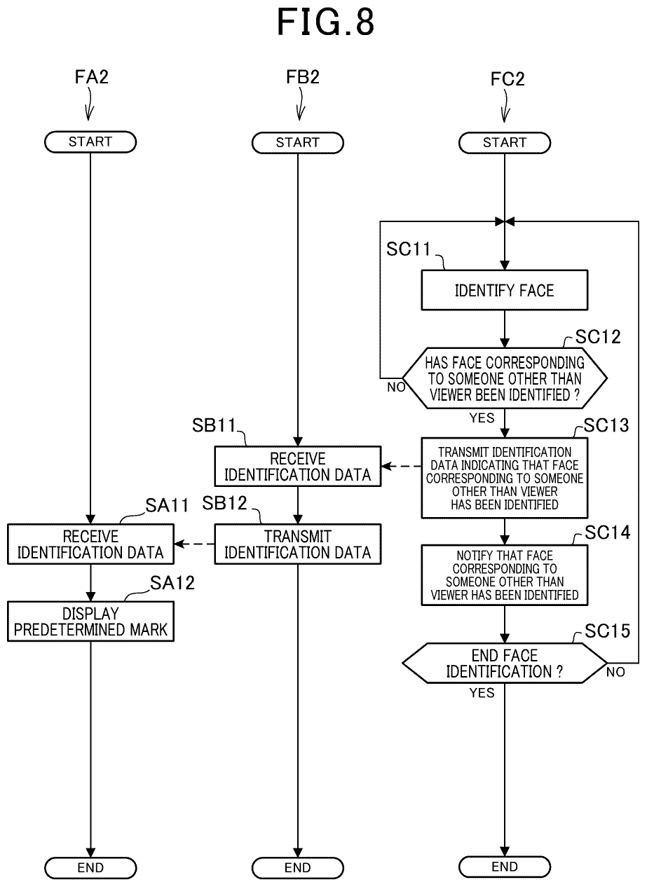

FIG. 8 shows flowcharts showing an operation of the in-vehicle apparatus 30, the streaming server 100, and the viewer terminal 200B.

The operation of each unit of the streaming system 1 in a period in which the APP 283 of the viewer terminal 200B can view the content will be described with reference to FIG. 8. The period in which the APP 283 of the viewer terminal 200B can view the content includes not only while the content is being output on the viewer terminal 200B, but also while the content is not being output.

In the operation of the in-vehicle apparatus 30, the streaming server 100, and the viewer terminal 200B described in FIG. 8, similar to the description of FIG. 7, it is assumed that communication is established between the in-vehicle apparatus 30 and the streaming server 100 and between the streaming server 100 and the viewer terminal 200B, and that the viewer terminal 200B can start viewing the streamed image.

Based on the above, while the viewer terminal 200B is not displaying the streamed image refers to the period in which the APP 283 of the viewer terminal 200B can view the streamed image.

In FIG. 8, a flowchart FA2 indicates the operation of the in-vehicle apparatus 30, a flowchart FB2 indicates the operation of the streaming server 100, and a flowchart FC2 indicates the operation of the viewer terminal 200B.

As shown in the flowchart FC2, the viewing-side face identification unit 293 identifies, based on the image obtained through capturing by the viewer terminal 200B, the face depicted in the image, regardless of whether the image and the speech included in the streamed content streamed by the streaming server 100 is being viewed in the period in which the APP 283 of the viewer terminal 200B can view the content (step SC11).

Subsequently, the viewing-side face identification unit 293 determines whether a face corresponding to someone other than the viewer U has been identified (step SC12). Steps SC11 and SC12 are an example of a “viewing-side face identification step.”

When a face corresponding to someone other than the viewer U has not been identified (NO in step SC12), the viewing-side face identification unit 293 returns the processing to step SC11.

When the viewing-side face identification unit 293 identifies a face corresponding to someone other than the viewer U (YES in step SC12), the viewing-side first notification unit 294 causes the viewing-side communication control unit 296 to transmit, to the streaming server 100, identification data including an instruction to display the predetermined mark on the screen of the touch panel 34 provided in the vehicle 3 (step SC13). Step SC13 is an example of a “first notification step.”

Subsequently, the viewing-side second notification unit 295 notifies the viewer U that a face corresponding to someone other than the specific viewer U has been identified (step SC14). Step SC14 is an example of a “second notification step.”

For example, the viewing-side second notification unit 295 performs the notification in step SC14 by causing, via the output unit 291, the light 201 to emit light of a predetermined color indicating that a face corresponding to someone other than the viewer U has been identified. For example, the viewing-side second notification unit 295 performs the notification in step SC14 by causing, via the output unit 291, the display 240 to display a screen including text or an image indicating that a face corresponding to someone other than the viewer U has been identified.

Subsequently, the viewing-side face identification unit 293 determines whether to end the face identification (step SC15). Specifically, the viewing-side face identification unit 293 determines whether the APP 283 of the viewer terminal 200B can view the content, and the viewing-side face identification unit 293 makes a positive determination in step SC15 when the APP 283 of the viewer terminal 200B cannot view the content.

When the APP 283 of the viewer terminal 200B cannot view the content corresponds to, for example, when the APP 283 has been stopped and when the communication between the viewer terminal 200B and the streaming server 100 or the in-vehicle apparatus 30 has been interrupted.

Subsequently, when the face identification has not been stopped (NO in step SC15), the viewing-side face identification unit 293 returns the processing to step SC11 and performs the processing from step SC11 onward once more. Note that the viewing-side face identification unit 293 continues the face identification until a negative determination is made in step SC15.

As shown in the flowchart FB2, the second control section 130 of the streaming server 100 receives the identification data from the viewer terminal 200B (step SB11) and transmits the received identification data to the in-vehicle apparatus 30 (step SB12).

As shown in the flowchart FA2, the streaming unit 354 of the in-vehicle apparatus 30 receives the identification data from the streaming server 100 (step SA11).

Subsequently, the vehicle-side display unit 351 displays the predetermined mark indicating that a face corresponding to someone other than the viewer U has been identified (step SA12). Step SA12 is an example of the “first notification step.”

### Other Embodiments

The above-described embodiment indicates merely one aspect and can be freely modified and applied.

In the above-described embodiment, the in-vehicle apparatus 30 identifies a face based on a capturing result from the first capturing apparatus provided in the vehicle 3. In another embodiment, the streaming server 100 may identify a face based on the capturing result from the first capturing apparatus provided in the vehicle 3. In the case of this configuration, the streaming server 100 stores data including information relating to the face of the specific occupant associated per vehicle 3. In the case of this configuration, the streaming server 100 acquires, from the in-vehicle apparatus 30, the capturing result from the first capturing apparatus. In the case of this configuration, the second processor 150 functions as the vehicle-side face identification unit 353 and the streaming unit 356, and the streaming server 100 identifies a face based on the image streamed from the in-vehicle apparatus 30 and streams the image to the viewer terminal 200B.

In the above-described embodiment, the viewer terminal 200B identifies a face based on a capturing result from the camera 230 being the example of the second capturing apparatus. In another embodiment, the streaming server 100 may identify a face based on the capturing result from the second capturing apparatus. In the case of this configuration, the streaming server 100 stores data including information relating to the face of a specific viewer associated per viewer terminal 200B. In the case of this configuration, the streaming server 100 acquires, from the viewer terminal 200B, the capturing result from the second capturing apparatus. In the case of this configuration, the second processor 150 functions as the viewing-side face identification unit 293, and the streaming server 100 identifies a face based on the capturing result acquired from the viewer terminal 200B.

In the above-described embodiment, the viewing-side first notification unit 294 of the viewer terminal 200B generates the instruction to display the predetermined mark on the display apparatus of the vehicle 3, as an example of the first notification unit. In another embodiment, the in-vehicle apparatus 30 may display the predetermined mark on the display apparatus of the vehicle 3, when receiving a signal indicating that the viewing-side face identification unit 293 has identified a face other than that of the specific viewer U. In this case, the first processor 350 of the in-vehicle apparatus 30 functions as the first notification unit.

In the above-described embodiment, the streaming unit 354 of the in-vehicle apparatus 30 uploads the content data to the streaming server 100 via the external communication I/F 31. In another embodiment, the streamer terminal 200A may upload the content data to the streaming server 100. More specifically, in this case, the streamer terminal 200A uploads, to the streaming server 100, the content data including the image captured by the camera included in the streamer terminal 200A and the speech input via the microphone included in the streamer terminal 200A.

The first processor 350 functions as the vehicle-side face identification unit 353, but is not limited thereto. In another embodiment, a processor of the streamer terminal 200A may function as the vehicle-side face identification unit 353.

The first processor 350 and the second processor 150 may be implemented as a single processor or as a plurality of processors. The first processor 350 and the second processor 150 may be hardware programmed to realize the above-described functional units. In this case, these processors are, for example, implemented as an application-specific integrated circuit (ASIC) or a field-programmable gate array (FPGA).

The configuration of each unit of the streaming server 100, the vehicle 3, and the viewer terminal 200B shown in FIGS. 2, 3, and 6 are merely examples, and specific implementation forms thereof are not particularly limited. In other words, it is not necessarily required that separate pieces of hardware be provided for the respective components, and the functions of the respective components may be realized by a single processor executing a program. Some functions realized by software in the above-described embodiment may be realized by hardware, or alternatively, some functions realized by hardware may be realized by software.

The step units of the operations shown in FIGS. 7 and 8 are divided in accordance with their main processing content, and the present invention is not limited by the manner in which the processing units are divided or by the names assigned to those processing units. One step unit may be divided into a greater number of step units in accordance with the processing content. One step unit may be divided so as to include a greater amount of processing. The order of these steps may be rearranged as appropriate so as not to impede the gist of the present invention.

### 6. Configurations Supported by the Above Embodiment

The above embodiment supports the following configurations.

### Configuration 1

A streaming system including: a streaming unit configured to stream an image obtained through capturing by a first capturing apparatus provided in a vehicle; a terminal apparatus provided in a location other than the vehicle and configured to display the streamed image; a viewing-side face identification unit configured to identify a face based on a capturing result from a second capturing apparatus provided in the terminal apparatus, while the terminal apparatus is displaying the streamed image; and a first notification unit configured to notify an occupant of the vehicle by displaying a predetermined mark on a display apparatus provided in the vehicle, when the viewing-side face identification unit identifies a face other than that of a specific viewer.

According to the streaming system of configuration 1, the occupant is notified that a face corresponding to someone other than the specific viewer has been identified, when a face corresponding to someone other than the specific viewer is identified. Thus, the occupant is capable of knowing whether the image displayed on the terminal apparatus is being viewed by a third party other than the specific viewer.

### Configuration 2

The streaming system according to configuration 1, including a second notification unit configured to notify the specific viewer that a face other than that of the specific viewer has been identified, when the viewing-side face identification unit identifies a face other than that of the specific viewer.

According to the streaming system of configuration 2, the viewer is notified that a face corresponding to someone other than the specific viewer has been identified, when a face corresponding to someone other than the specific viewer is identified. Thus, the viewer is capable of confirming that a third party other than the specific viewer has been identified.

### Configuration 3

The streaming system according to configuration 1 or 2, including: a vehicle-side face identification unit configured to identify a face based on a capturing result from the first capturing apparatus; and a prohibition unit configured to prohibit streaming of the image by the streaming unit, when the vehicle-side face identification unit identifies a face of an occupant other than that of a specific occupant.

According to the streaming system of configuration 3, it is possible to prohibit streaming of an image in which a third party other than the specific occupant is depicted. Thus, it is possible to prevent a third party from unintentionally streaming an image.

### Configuration 4

The streaming system according to configuration 1 or 2, wherein the viewing-side face identification unit identifies a face based on the capturing result from the second capturing apparatus, even while the terminal apparatus is not displaying the streamed image.

According to the streaming system of configuration 4, the occupant is notified, before the terminal apparatus displays the streamed image, that a face corresponding to someone other than the specific viewer has been identified, when a face corresponding to someone other than the specific viewer is identified. Thus, the occupant is capable of knowing whether the image displayed on the terminal apparatus is being viewed by a third party other than the specific viewer before streaming the image.

### Configuration 5

A non-transitory computer-readable storage medium storing a program for causing a processor of a terminal apparatus provided in a location other than a vehicle and configured to display a streamed image obtained through capturing by a first capturing apparatus provided in the vehicle, to function as: a viewing-side face identification unit configured to identify a face based on a capturing result from a second capturing apparatus included in the terminal apparatus; and a first notification unit configured to notify an occupant of the vehicle by displaying a predetermined mark on a screen of a display apparatus provided in the vehicle, when the viewing-side face identification unit identifies a face other than that of a specific viewer.

According to the program of configuration 5, it is possible to achieve the same effects as the streaming system of configuration 1.

### Configuration 6

A streaming method including: a streaming step of streaming an image obtained through capturing by a first capturing apparatus provided in a vehicle; a viewing-side display step of displaying, by a terminal apparatus provided in a location other than the vehicle, the streamed image; a viewing-side face identification step of identifying a face based on a capturing result from a second capturing apparatus provided in the terminal apparatus, while the terminal apparatus is displaying the streamed image; and a first notification step of notifying an occupant of the vehicle by displaying a predetermined mark on a display apparatus provided in the vehicle, when a face other than that of a specific viewer is identified in the viewing-side face identification step.

According to the streaming method of configuration 6, it is possible to achieve the same effects as the streaming system of configuration 1.

### Reference Signs List

1 streaming system
3 vehicle
5 communication network
30 in-vehicle apparatus
31 external communication I/F
32 first short-range wireless communication I/F
33 internal communication I/F
34 touch panel (display apparatus)
35 speech processing unit
36 speaker
40 vehicle ECU
100 streaming server
110 network communication I/F
130 second control section
140 second memory
141 control program
143 user information database
145 stream management database
150 second processor
200A streamer terminal (first capturing apparatus)
200B viewer terminal (terminal apparatus)
201 light
210 wireless communication I/F
230 camera (second capturing apparatus)
240 display
250 microphone
260 speaker
270 third control section
280 third memory
281 OS
283 APP (program)
285 viewing-side face data
290 third processor
291 output unit (viewing-side display unit)
292 viewing-side reception unit
293 viewing-side face identification unit
294 viewing-side first notification unit (first notification unit)
295 viewing-side second notification unit (second notification unit)
296 viewing-side communication control unit
300 in-vehicle ECU
310 input/output I/F
330 first control section
340 first memory
345 control program
346 vehicle-side face data
350 first processor
351 vehicle-side display unit
352 vehicle-side reception unit
353 vehicle-side face identification unit
354 streaming unit (prohibition unit)
S streamer (occupant)
U viewer

1. A streaming system comprising:
a streaming unit configured to stream an image obtained through capturing by a first capturing apparatus provided in a vehicle;
a terminal apparatus provided in a location other than the vehicle and configured to display the streamed image;
a viewing-side face identification unit configured to identify a face based on a capturing result from a second capturing apparatus provided in the terminal apparatus, while the terminal apparatus is displaying the streamed image; and
a first notification unit configured to notify an occupant of the vehicle by displaying a predetermined mark on a display apparatus provided in the vehicle, when the viewing-side face identification unit identifies a face other than that of a specific viewer.

2. The streaming system according to claim 1, further comprising a second notification unit configured to notify the specific viewer that a face other than that of the specific viewer has been identified, when the viewing-side face identification unit identifies a face other than that of the specific viewer.

3. The streaming system according to claim 1, comprising:
a vehicle-side face identification unit configured to identify a face based on a capturing result from the first capturing apparatus; and
a prohibition unit configured to prohibit streaming of the image by the streaming unit, when the vehicle-side face identification unit identifies a face of an occupant other than that of a specific occupant.

4. The streaming system according to claim 1, wherein
the viewing-side face identification unit identifies a face based on the capturing result from the second capturing apparatus, even while the terminal apparatus is not displaying the streamed image.

5. A non-transitory computer-readable storage medium storing a program for causing a processor of a terminal apparatus provided in a location other than a vehicle and configured to display a streamed image obtained through capturing by a first capturing apparatus provided in the vehicle, to function as:
a viewing-side face identification unit configured to identify a face based on a capturing result from a second capturing apparatus included in the terminal apparatus; and
a first notification unit configured to notify an occupant of the vehicle by displaying a predetermined mark on a screen of a display apparatus provided in the vehicle, when the viewing-side face identification unit identifies a face other than that of a specific viewer.

6. A streaming method comprising:
a streaming step of streaming an image obtained through capturing by a first capturing apparatus provided in a vehicle;
a viewing-side display step of displaying, by a terminal apparatus provided in a location other than the vehicle, the streamed image;
a viewing-side face identification step of identifying a face based on a capturing result from a second capturing apparatus provided in the terminal apparatus, while the terminal apparatus is displaying the streamed image; and
a first notification step of notifying an occupant of the vehicle by displaying a predetermined mark on a display apparatus provided in the vehicle, when a face other than that of a specific viewer is identified in the viewing-side face identification step.
